(19) United States
(12) Patent Application Publication
(10) Pub. No.: US 2014/0188715 A1
(43) Pub. Date: Jul. 3, 2014

(54) SYSTEMS AND METHODS FOR BILL PAYMENT WITH IMAGE CAPTURE OF BILL INFORMATION AND FUNDING ACCOUNT

(71) Applicant: FISERV, INC., Brookfield, WI (US)

(72) Inventors: Todd Christopher Barlok, Trussville, AL (US); Michelle Mann Flint, Cumming, GA (US); Ashley Eigher Noto, Atlanta, GA (US); Timothy Patrick Sheehan, Decatur, GA (US)

(73) Assignee: FISERV, INC., Brookfield, WI (US)

(21) Appl. No.: 13/731,860

(22) Filed: Dec. 31, 2012

(51) Int. Cl. G06Q 20/14

(52) U.S. Cl. CPC G06Q 20/14
USPC 705/40

(57) ABSTRACT

Systems and methods that receive one or more images and based at least in part on the received images identify information associated with a bill and information associated with a mode of payment and, based at least in part on the information associated with the bill and information associated with the mode of payment, effectuate a financial transaction.

### FIELD OF THE DISCLOSURE

The present disclosure relates to systems and methods for bill payment.

### BACKGROUND OF THE DISCLOSURE

There are currently financial systems, such as electronic bill presentment and payment (EBPP) systems, where a billing entity sends an electronic bill and a payer pays the bill electronically, such as over the Internet. Typically when these systems are used, the electronic bill may arrive at a particular financial account associated with the payer. Therefore, the payer may need to specify details of a funding account the first time that the payer uses the EBPP system. In some cases, the payer may need to specify details of a funding account each time the payer uses the EBPP system. In some further cases, the payer may not have a choice of which account he/she may use to pay the electronic bill. Additionally, if a biller provides a non-electronic bill, then the payer may be required to manually enter information associated with the bill into a bill payment system to execute payment of the received bill.

### BRIEF DESCRIPTION OF THE FIGURES

Reference will now be made to the accompanying drawings, which are not necessarily drawn to scale, and wherein:

FIG. 1 is a simplified schematic diagram illustrating an example architecture for bill payment in accordance with illustrative embodiments of the disclosure.

FIG. 2 is a simplified schematic diagram illustrating example interactions between the various entities of the architecture of FIG. 1 in accordance with illustrative embodiments of the disclosure.

FIGS. 3A and 3B are a flow diagram illustrating an example method performed by a user device for bill payment in accordance with illustrative embodiments of the disclosure.

FIG. 4 is a flow diagram illustrating an example method performed by a payment system for bill payment in accordance with illustrative embodiments of the disclosure.

FIG. 5 is a flow diagram illustrating an example method for transmitting bill data elements associated with a bill in accordance with illustrative embodiments of the disclosure.

FIG. 6 is a schematic representation of an example image of a bill with bill data elements in accordance with illustrative embodiments of the disclosure.

FIG. 7 is a flow diagram illustrating an example method for providing one or more payment instrument data elements in accordance with illustrative embodiments of the disclosure.

FIG. 8 is a schematic representation of an example image of a payment instrument with payment instrument data elements in accordance with illustrative embodiments of the disclosure.

FIG. 9 is a schematic representation of another example image of a payment instrument with payment instrument data elements in accordance with illustrative embodiments of the disclosure.

FIG. 10 is a flow diagram illustrating an example method for directing a bill payment in accordance with illustrative embodiments of the disclosure.

### DETAILED DESCRIPTION OF EMBODIMENTS OF THE DISCLOSURE

Embodiments of the disclosure are described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

Embodiments of the disclosure may provide systems and methods that receive one or more images and based at least in part on the received images identify information associated with a bill and information associated with a mode of payment and, based at least in part on the information associated with the bill and information associated with the mode of payment, effectuate a financial transaction. The bill payment processing may involve determining one or more bill data elements from an image of at least a portion of a bill to be paid, determining one or more payment instrument data elements form an image of at least a portion of a payment instrument, and authorizing and instantiating a bill payment based at least in part on the one or more bill data elements and the payment instrument data elements.

Effecting bill payments in accordance with embodiments of the disclosure may entail image processing of a bill image of at least a portion of a bill to be paid to a biller or payee. The bill image may be captured by any suitable entity, such as the payer of the bill, a bill payment service provider, the consumer associated with the biller, or the biller. In certain embodiments of the disclosure, the bill image may be captured by the payer using a user device, such as a computing device and/or computer peripheral driving an image scanner, image sensor, and/or camera. Thus, the user device may be configured to capture the bill image, independently or in conjunction with other entities or other hardware and/or software elements. In these embodiments, the user device may be used to capture an image of the bill in paper form using any suitable image capture device, such as a scanner, image sensor, camera, or the like. In certain other embodiments, the user device may be configured to receive the bill image from the biller or any other suitable entity, such as in digital form via the Internet. The user device may be further configured to transmit the bill image to a payment system for image processing and determination of one or more bill data elements. The user device may, therefore, include one or more processor(s) and one or more memories with instructions and/or applications stored thereon that may enable the user device to perform a variety image capture, image processing, image and/or data processing, image and/or data communications, and/or user interaction functions. In certain embodiments, the user device may interact with a web based application served by one or more servers to provide the aforementioned functionality. In these embodiments, the instructions and/or application may not be stored on the user device and instead may be interacted with by the payer via a user interface (UI) rendered on the user device, using one or more applications on the user device, such as a web browser. The user device and the processor(s) thereon may execute one or more bill payment applications to perform the functions as described herein. The user device, image capture component (e.g., a scanner, which may be part of a printer), and user application functionality supporting this processing, whether on the user device or at a remote computer, together may comprise a payment application system.

The payment system may utilize a variety of techniques to process and/or analyze the bill image received from the user device on behalf of the payer. These techniques may involve image improvement techniques, such as image sharpening, image reorienting, or the like. The techniques may further involve mechanisms for identifying bill image fields, text, and/or images, such as optical character recognition (OCR). The payment system may identify one or more fields or textual indicators on the bill image to determine one or more bill data elements. The one or more bill data elements may pertain to at least one of when, where, how, how much, and on behalf of whom to pay the biller. Indeed the one or more bill data elements may include payment address, payment due date, payment amount, or the like. In some cases, the bill image may include an image of a bill payment coupon and the one or more bill data elements may be ascertained form the image of the payment coupon. The payment system may, therefore, include one or more processor(s) and one or more memories with instructions and/or applications stored thereon that may enable the user device to perform a variety of image capture functionality, image processing, image and/or data processing, image and/or data communications, and/or user interaction functions. Upon identifying the one or more bill data elements, the payment system may communicate the one or more bill data elements, or an indication thereof, to the user device. It will be appreciated that in certain embodiments, some or all of the process of identifying the bill data elements may be performed at the user device. For example, image improvement techniques, such as image sharpening, may be performed at the user device and bill image field identification may be performed at the payment system.

The user device upon receiving the one or more bill data elements may present the bill data elements to the payer by any suitable mechanism, such as rendering the one or more bill data elements on a display screen. The user device may further solicit a response from the payer indicative of either approval of the one or more bill data elements or an indication of at least one of the one or more bill data elements that should be modified. The payer, therefore, may be able to modify the one or more bill data elements, such as by changing the payment amount or payment date. Once the payer provides approval or a final set of one or more approved bill data elements to the user device, the user device may transmit the one or more approved bill data elements, or an indication thereof, to the payment system.

The user device may next provide a payment instrument image of a payment instrument, such as a check, credit card, debit card, and/or prepaid card, or a portion thereof, to the payment system. As in the case of the bill image, the user device may be used to capture an image of the payment instrument, or a portion thereof, using any suitable image capture device, such as a scanner, image sensor, or the like. In certain other embodiments, the user device may be configured to receive the payment instrument image form the memory of the user device or any other suitable entity, such as a remote and/or cloud server, in digital form via the Internet or other communicative links That UI “form” may provide instructions for driving the image capture process, then reflect the capture image and/or extracted elements in a subsequent presentation.). The payment instrument image may include any one or more of an image of a front of a check, a front of a card, such as a credit, debit, or prepaid card, or a back of a card, such as a credit, debit, or prepaid card. The user device may be further configured to transmit the payment instrument image to a payment system for image processing and extraction of one or more payment instrument data elements.

Similar to the processing of the bill image, the payment system may perform a variety of image processing and/or character recognition tasks to determine one or more payment instrument data elements form the payment instrument image. Upon the determination of the payment instrument data elements, the payment system may transmit the one or more payment instrument data elements, or indications thereof, to the user device. Similar to the process of the one or more bill data elements, the user device and application(s) running thereon may solicit one of an approval or modification of the one or more payment instrument data elements from the payer. Upon generation of a set of approved one or more payment instrument data elements, the user device may transmit the one or more approved payment instrument data elements to the payment system.

The user device may next generate and transmit a payment request to the payment system. This payment request may be indicative of the payer's desire to pay the bill associated with the bill image using the payment instrument associated with the payment instrument image. The payment system may then receive the payment request. Upon receiving the payment request, the payment system may proceed with payment request processing, which may involve one or more of validating the payment request, storing the payment request, determining ability to proceed with fulfilling the payment request, and effecting payment from the financial institution associated with the payment instrument to the biller. In one aspect, the payment system may direct a debit from the payer's financial institution and may direct a credit to the biller and/or the biller's financial institution. In certain embodiments, the debit amount may be equal to the credit amount. In these embodiments, the credit and debit amounts may each be equal to a bill payment amount as provided on the bill associated with the bill image. In certain other embodiments, the debit amount and the credit amount may be different from each other. In these embodiments, the debit amount may be greater than the credit amount. In one aspect, the credit amount may be equal to a bill payment amount as provided on the bill associated with the bill image.

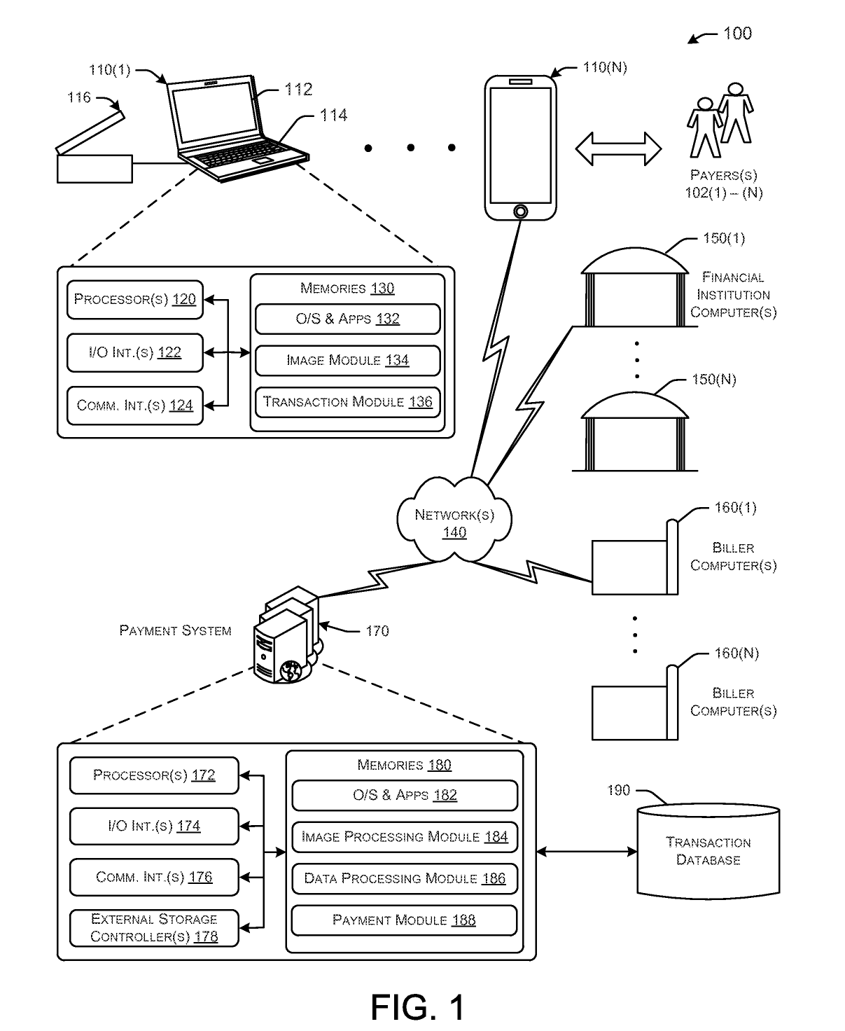

Referring now to FIG. 1, example architecture 100 for bill payments in accordance with embodiments of the disclosure is disclosed. The architecture 100 may include one or more payers 102(1)-(N), collectively referred to as payers 102, that can access a corresponding user device 110(1)-(N), collectively referred to as user device 110. The user devices 110 may be configured to communicate via one or more networks 140 or other suitable communicative connections. The architecture 100 may further include one or more financial institution computers 150(1)-(N), collectively referred to as financial institution computers 150, and one or more biller computers 160(1)-(N), collectively referred to as biller computers 160. The financial institution computers 150 and the biller computers 160 may be configured to communicate via the networks 140 or other suitable communicative connections. The architecture may yet further include one or more payment systems 170 configured to communicate via the networks 140 or other suitable communicative connections.

The payers 102 may be individuals or other entities, such as corporations, non-profit organizations, for-profit organizations, government organizations, public sector organizations, or any of the aforementioned entities located in this or foreign countries. The user devices 110 may be any suitable electronic device that may be used by a payer 102 to interact with services provided by the user device 110 or other entities of the architecture 100. The user device 110 may include, but is not limited to, a personal computer, a desktop computer, a notebook computer, a laptop computer, a personal digital assistant, an electronic book (ebook) reader, a tablet computing device, a pad computing device, a smart phone, or combinations thereof. The user device 110 may include one or more input and/or output (I/O) components, such as one or more display(s) 112, one or more keyboard(s) 114, and/or one or more image scanner(s) 116. Other examples of I/O components of a user device 110 may include one or more, microphone(s), accelerometer(s), gyroscope(s), touch sensitive screen(s), electronic storage device(s), one or more mice, or the like. Each of these I/O components 112, 114, 116 may be configured to provide a functionality by the user device 110 such as ability to render information to the payer 102, such as with the display 112, accept information from the payer 102, ability to accept input from the payer 102, such as with the keyboard 114, or sensing an image, such as with the image scanner 116. The I/O components 112, 114, 116 may be configured to provide signal(s), such as an input and/or output signal, associated with the I/O component. For example, the image scanner 116 may provide an image sensor signal corresponding to an image captured by the image scanner 116.

The image scanner 116 may be any known scanning device, or otherwise a device that may generate an image from a document, including, but not limited to, a flatbed scanner, a handheld scanner, a combination scanner/copier, a combination scanner/facsimle machine, or the like. The image scanner 116, in certain embodiments, may include any known variety of image sensors, including a charge coupled device (CCD), complementary metal oxide semiconductor (CMOS) sensors, or the like. The image scanner 116 may further be of any pixel count and aspect ratio. While the image scanner 116 is depicted as a digital flatbed scanner communicatively coupled to the user device 110, it will be appreciated that the image scanner 116 may alternatively be in to the form of a digital camera, a web camera, a smart phone or tablet computer camera, or the like.

The user devices 110 may include one or more processors 120, one or more input/output (I/O) interfaces 122, one or more communications interfaces 124, and/or one or more memories 130. It will be appreciated that the user devices 110 may include other components or elements that enable the user devices 110 to perform the methods and processes described herein in accordance with embodiments of the disclosure.

The one or more processors 120 may be configured to execute and/or operate one or more instructions, applications, and/or software in one or more memories 130 of the user device 110 to provide services to the payers 102 associated with the user device 110. The processors 120 may further be configured to receive input from or provide output to the components 112, 114, 116 and other components, of the user device 110. For example, the processors 120 may be configured to direct the operation of the image scanner 116 and/or receive an image sensor signal and/or image sensor data associated with an image captured using the image scanner 116.

In some examples, the one or more processors 120 of the user device 110 may be implemented as appropriate in hardware, software, firmware, or combinations thereof. Software or firmware implementations of the one or more processors 120 may include computer-executable or machine-executable instructions written in any suitable programming language to perform the various functions described. Hardware implementations of the processors 120 may be configured to execute computer-executable or machine-executable instructions to perform the various functions described. The one or more processors 120 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The user device 110 may also include a chipset (not shown) for controlling communications between the one or more processors 120 and one or more of the other components of the user device 110. The one or more processors 120 may also include one or more application specific integrated circuits (ASICs) or application specific standard products (ASSPs) for handling specific data processing functions or tasks.

The I/O interfaces(s) 122, may include any suitable interface configured to interface between the processors 120 and the components 112, 114, 116 of the user device 110. The communications interfaces(s) 124 may allow the user devices 110 to communicate with stored databases, other computing devices or servers, user terminals, and/or other devices on the networks 140 or other suitable communicative channels.

The memory 130 may include one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof. The memory 130 may store program instructions that are loadable and executable on the processor(s) 120, as well as data generated or received during the execution of these programs. Turning to the contents of the memory 130 in more detail, the memory 130 may include an operating system (O/S) and/or applications 132, an image module 134, and/or a transaction module 136. Each of the modules and/or software may provide functionality for the user device 110, when executed by the processors 120. The modules and/or the software may or may not correspond to physical locations and/or addresses in memory 130. In other words, the contents of each of the modules may not be segregated from each other and may, in fact be stored in at least partially interleaved positions on the memory 130. In certain embodiments, each of the modules 132, 134, 136 may be divided with greater granularity. In other words, each of the modules 132, 134, 136 may include sub-modules. For example, individual applications within the O/S and/or application module 132 may be sub-modules of the O/S and/or application module 132.

The O/S and/or applications 132 may have one or more operating systems stored thereon. The processors 120 may be configured to access and execute one or more operating systems stored in the O/S and applications module 120 to operate the system functions of the user devices 110. System functions, as managed by the O/S may include memory management, processor resource management, driver management, application software management, system configuration, and the like. The O/S may be any variety of suitable operating systems including, but not limited to, Google® Android®, Microsoft® Windows®, Microsoft® Windows® Server®, Linux, Apple® OS-X®, Apple® iOS®, or the like. The O/S and applications module 132 may additionally have one or more software applications stored thereon that may be accessed and executed by the processors 120 to provide user device 110 functionality and services to the payer 102 using the user device 110.

The image module 134 may have stored thereon instruction and/or programs that when executed by the processors 120, may enable the user device 110 to capture, store, and/or manage various aspects of images, such as digital images and associated digital image files. In one aspect, the instructions and/or programs stored in the image module 134 may configure the processors 120 to receive signals from the image scanner 116 and construct an image file therefrom. The user device 110, by executing instructions stored in the image module 134, may be configured to store image data files in the memory 130. The processors 120 may further be configured to provide and/or transmit one or more images or associated image files and/or image related data to the payment system 170 or other entities via the networks 140 or other suitable communicative connections. The processors 120, by executing instructions stored in the image module 134, may further be configured to receive images from the one or more entities, such as the biller computers 160 and/or the financial institution computers 150 or other suitable entities, via the networks 140 or other suitable communicative connections. The processors 120 may yet further be configured to manage images that are stored in one or more databases, such as in the memory 130 or a suitable database external to the user device 110. In one aspect, the processors 120, by running instructions and/or programs stored on the image module 134, may be configured to render one or more images on the display 112. In another aspect, the processors 120, by running instructions and/or programs stored on the image module 134, may be able to manipulate images and associated files and/or data, such as concatenating two or more images.

The transaction module 136 may have stored thereon instruction and/or programs that when executed by the processors 120, may enable the user device 110 to perform various functions associated with instantiating one or more financial transactions. In one aspect, the processors 120, by executing instruction stored on the transaction module may be able to display data elements associated with one or more images. These data elements may include data elements associated with one or more of a bill from a biller or a payment instrument associated with a financial institution and associated with a financial account. In certain embodiments, the processors 120 may be configured to receive these data elements from the payment system 170 or other entities via the networks 140 or other suitable communicative connections. The processors 120, by executing instructions stored in the transaction module 136, may further be configured to render the received data elements, such as bill data elements and/or payment instrument data elements, on the display 112 of the user device 110. Further still, the processors 120, by executing instructions stored in the transaction module 136, may be configured to receive payer 102 input in approving and/or modifying the data elements, such as bill data elements and/or payment instrument data elements that are displayed on the display 112 of the user device 110. In one aspect, the processors 120 may receive an input from the payer 102 via the keyboard 114 or other suitable I/O component of the user device 110.

The transaction module 136 may further have stored thereon instruction and/or programs that when executed by the processors 120, may enable a payer 102 using the user device 110 to direct, submit, transmit, and/or instantiate a financial transaction, such as a bill payment. Such a transaction may entail, receiving payer input via one or more I/O components 112, 114, 116, of the user device 110 of the user submission of a request for a financial transaction. In one aspect, the directing of the financial transaction may entail generation and transmittal of a payment request to the payment system 170 or other suitable entity via the networks 140 or other suitable communicative connection. The payment request may indicate a payer instruction to execute a financial transaction and may be acted on by the payment system and/or other entities, when received, to effect the financial transaction. The user interaction for soliciting approval and/or modification of the proposed payment may be conducted via one or more of suitable I/O components 112, 114, 116 of the user device 110.

It should be noted that the instructions, applications, and/or software, as stored in the various modules 132, 134, 136, may be download from a server by the user device 110 via the networks 140 or other suitable communicative connections. In certain embodiments, the user device 110 may be configured to download a bill payment application installer via the Internet and then the processors 120 may be configured to execute the installation program to store appropriate instructions in the O/S and/or applications module 132, image module 134, and/or the transaction module 136. In other non-limiting examples, a thin client user interface may be received by the user device 110 and rendered o the payer 102 utilizing software, such as a web page viewer, to interact with the payer 102 for the instantiating the transaction.

It will be appreciated that there may be overlap in the functionality of the instructions stored in the O/S and/or applications module 132, image module 134, and the transaction module 136. In fact, the functions of the three aforementioned modules 132, 134, and 136 may interact and cooperate seamlessly under the framework of the user device 110. Indeed, each of the functions described for any of the modules 132, 134, 136 may be stored in any other module 132, 134, 136 in accordance with certain embodiments of the disclosure. Further, in certain embodiments, there may be one single module that includes the instructions, programs, and/or applications described within the O/S and applications module 132, image module 134, and the transaction module 136.

The financial institution computers 150 may be affiliated with a variety of financial institutions. Each of these financial institutions may be affiliated with any one or more of the payer 102, the biller, or the payment system 170. In one aspect the financial institution computers 150 associated with a particular financial account of the payer 102 may be configured to receive a debit instruction to debit a specified amount of money from the account of the payer 102. In another aspect the financial institution computers 150 associated with a particular financial account of the biller may be configured to receive a credit instruction to credit a specified amount of money to an account of the biller. In certain embodiments, the financial institution computers 150 may be configured to receive credit and/or debit instructions from the payment system 170 and/or other entities of the architecture 100 via the networks 140 and/or other suitable communicative links. In certain embodiments, one or more financial institutions and their corresponding respective financial institution computers 150 may be associated with the payment system 170 and may provide financial accounts and/or financial services to the one or more entities associate with the payment system 170. In these embodiments, the financial accounts associated with the payment system 170 may be used as an intermediary account and the payment system 170 may use these intermediary accounts to fulfill a bill payment transaction. In other words, the payment system 170 may be configured to coordinate a debit transaction from a financial account associated with the payer 102 and a corresponding credit transaction to a financial account associated with the payment system 170. The payment system may further be configured to coordinate a debit transaction from the financial account associated with the payment system 170 and a corresponding credit transaction to a financial account associated with the biller.

The biller computers 160 may be affiliated with one or more billers and may be configured to communicate with the user devices 110 to provide a bill to a payer 102 associated with the user device 110. Therefore, in certain embodiments, the biller computers 160, or a service provider thereof, may be configured to provide the payer 102 with a digital image of a bill for services that may have been rendered by the biller. In certain embodiments, the service provider assocaited with the biller may be the service provider associated with the payment system 170. In other embodiments, the biller and/or the biller computers 160 may generate a bill printed on paper and may provide the paper bill to the payer via any suitable mechanism including postal and/or currier services. For the purposes of this disclosure, the biller may be any entity that provides a bill, either electronically or in physical form, to the payer 102. The biller may provide the bill for services rendered that include utilities, telecommunications, media content delivery, transportation services, retail services, lawn services, repair services, or the like.

The payment systems 170 may include one or more processors 172, one or more input/output (I/O) interfaces 174, one or more communications interfaces 174, one or more external storage controllers 178, and/or one or more memories 180. It will be appreciated that the payment systems 170 may include other components or elements that enable the payment systems 170 to perform the methods and processes described herein in accordance with embodiments of the disclosure.

The I/O interfaces(s) 174, may include any suitable interface configured to interface between the processors 172 and one or more I/O components (not shown) of the payment system 170. The I/O interface(s) may enable users to interact with the payment system 170 locally. The communications interfaces(s) 124 may allow the payment system 170 to communicate with stored databases, other computing devices or servers, user terminals, and/or other devices via the networks 140 or other suitable communicative channels. The external storage controllers 178 may enable communications with one or more external storage devices and/or databases, such as a transaction database 190 as illustrated.

The memory 180 may include one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof. The memory 130 may store program instructions that are loadable and executable on the processor(s) 172, as well as data generated or received during the execution of these programs. Turning to the contents of the memory 180 in more detail, the memory 180 may include an operating system (O/S) and/or applications 182, an image processing module 184, a data processing module 186, and/or a payment module 188. Each of the modules and/or software may provide functionality for the payment system 170, when executed by the processors 172. The modules and/or the software may or may not correspond to physical locations and/or addresses in memory 180. In other words, the contents of each of the modules may not be segregated from each other and may, in fact be stored in at least partially interleaved positions on the memory 180. The O/S and/or applications 182 may be the same or similar to the O/S and/or applications 132 of the user device and, therefore, in the interest of brevity, the description of the O/S and/or applications 182 will not be repeated here.

The image processing module 184 may have instructions and/or applications stored thereon that may be accessed and/or executed by the processors 172, thereby enabling the processors 172 to perform a variety of image processing tasks. These image processing tasks may entail receiving images, storing and/or retrieving stored images, performing image processing on received and/or stored images, extracting information and/or data elements from images, or the like.

Receiving images may entail receiving an image from another entity of the architecture 100. In other cases, the processors 172 may retrieve or receive images, such as bill images and/or payment instrument images, from the memory 180, transaction database 190, or other storage locations accessible by the payment system 170. For example, the payment system 170 and the processors 172 thereon, may receive a bill image of a bill or a portion thereof from the user device 110. In some cases, the bill image may be an image of a payment coupon of a bill. As another example, the payment system 170 and the processors 172 thereon, may receive a payment instrument image of a payment instrument or a portion thereof from the user device 110. In certain embodiments, the payment instrument may be one or more of a check, a credit card, a debit card, a prepaid card, or the like. In these cases, the payment instrument image may include an image of a front of a check, an image of a back of a check, an image of a front of a credit card, an image of a back of a credit card, an image of a front of a debit card, an image of a back of a debit card, an image of a front of a prepaid card, an image of a back of a prepaid card, or combinations thereof.

Performing image processing and/or extracting data elements form images may be performed by the processors 172 by performing a variety of algorithms. Therefore, the processors 172 may be configured to perform image filtering, image sharpening, modifying an image orientation, modifying the dithering of one or more pixels of the image, modifying the contrast of the image, modifying the brightness of the image, processing metadata associated with the image, image field recognition, text sequence recognition, optical character recognition, intelligent character recognition, or the like. It will be appreciated that the aforementioned algorithms are not, in any way, an exhaustive list of image processing and/or manipulation algorithms and embodiments of the disclosure may utilize algorithms that are not listed in the preceding list. It will further be appreciated that some or all of the aforementioned alogorithms may be performed by the user device 110 and the processors 120 thereon.

In one aspect, the processors 172, by executing instructions stored in the image processing module, may be configured to extract particular data elements from particular image types. For example, the payment system 170 may be configured to receive a bill image of a bill or a portion thereof and from the bill image, the payment system 170 may be configured to extract bill data elements, such as an identification of the biller, an identification of the biller's address, an identification of the biller's payment address (if different from the biller address), an identification of the biller's telephone number, an identification of a consumer, an identification of the consumer's account number, an identification of the consumer's address, an invoice number, a payment due date, a payment amount, or the like. As another example, the payment system 170 may be configured to receive a payment instrument image of a payment instrument or a portion thereof and from the payment instrument image, the payment system 170 may be configured to extract payment instrument data elements, such as an identification of a payment instrument type, an identification of the payer's address, an identification of the payer's payment address, an identification of the payer's telephone number, an identification of the financial account, an identification of a financial account number, an identification of a routing number, an identification of a check number, an expiration date, a card verification value (CVV), or combinations thereof.

The data processing module 186 may have instructions and/or applications stored thereon that may be accessed and/or executed by the processors 172, thereby enabling the processors 172 to perform a variety of data processing tasks. These data processing tasks may entail communicating data elements and/or approved data elements, analyzing data elements, storing and/or managing transaction histories, and receiving and/or analyzing financial account information. In one aspect, the processors 172 may be configured to transmit a variety of image related data elements to the user device 110 of a particular payer 102 via the networks 140 or other suitable communicative connections. For example, the payment system 170 may be configured to transmit bill data elements and/or payment instrument data elements that may be determined by the payment system 170 from bill images and/or payment instrument images received by the payment system 170. As another example, the payment system 170 may be configured to receive one or more approved bill data elements and/or one or more approved payment instrument data elements from the user device 110.

The payment module 188 may have instructions and/or applications stored thereon that may be accessed and/or executed by the processors 172, thereby enabling the processors 172 to perform a variety of payment and/or bill payment tasks. These bill payment tasks may entail receiving a payment request, instantiating one or more debit transactions, instantiating one or more credit transactions, and/or providing confirmation of bill payment. By executing the instructions stored in the payment module 188, the processors 172 may be configured to receive a payment request from the user device 110 or other entities. Furthermore, the processors 172 may be configured to generate and/or transmit one or more credit and/or debit instructions based at least in part on the received payment request to one or more financial institution computers 150. The processors 172 may, yet further, be configured to receive a confirmation of the execution of individual credit and/or debit instructions from the financial institution computers 150. The processors 172, upon receiving confirmation of the execution of one or more credit and/or debit transactions associated with a payment request, may be configured to provide a confirmation of bill payment. This confirmation of bill payment may be transmitted by the payment system 170 to the user device 110 via the networks 140 or other suitable communicative connections. In some cases, the confirmation may be transmitted upon the payment system successfully completing its processing and initiating transactions, without having received confirmation itself (some payment mechanisms, like the ACH network, may not provide positive confirmation).

It will be appreciated that there may be overlap in the functionality of the instructions stored in the O/S and/or applications module 182, image processing module 184, data processing module 186, and the payment module 188. In fact, the functions of the four aforementioned modules 182, 184, 186, 190 may interact and cooperate seamlessly under the framework of the payment system 170. Indeed, each of the functions described for any of the modules 182, 184, 186, 188 may be stored in any other module 182, 184, 186, 188 in accordance with certain embodiments of the disclosure. Further, in certain embodiments, there may be one single module that includes the instructions, programs, and/or applications described within the O/S and applications module 182, image processing module 184, data processing module 186, and the payment module 188.

The networks 140 may include any one or a combination of different types of suitable communications networks, such as cable networks, the Internet, wireless networks, cellular networks, and other private and/or public networks. Furthermore the networks 140 may include any variety of medium over which network traffic is carried including, but not limited to, coaxial cable, twisted wire pair, optical fiber, hybrid fiber coaxial (HFC), microwave terrestrial transceivers, radio frequency communications, satellite communications, or combinations thereof.

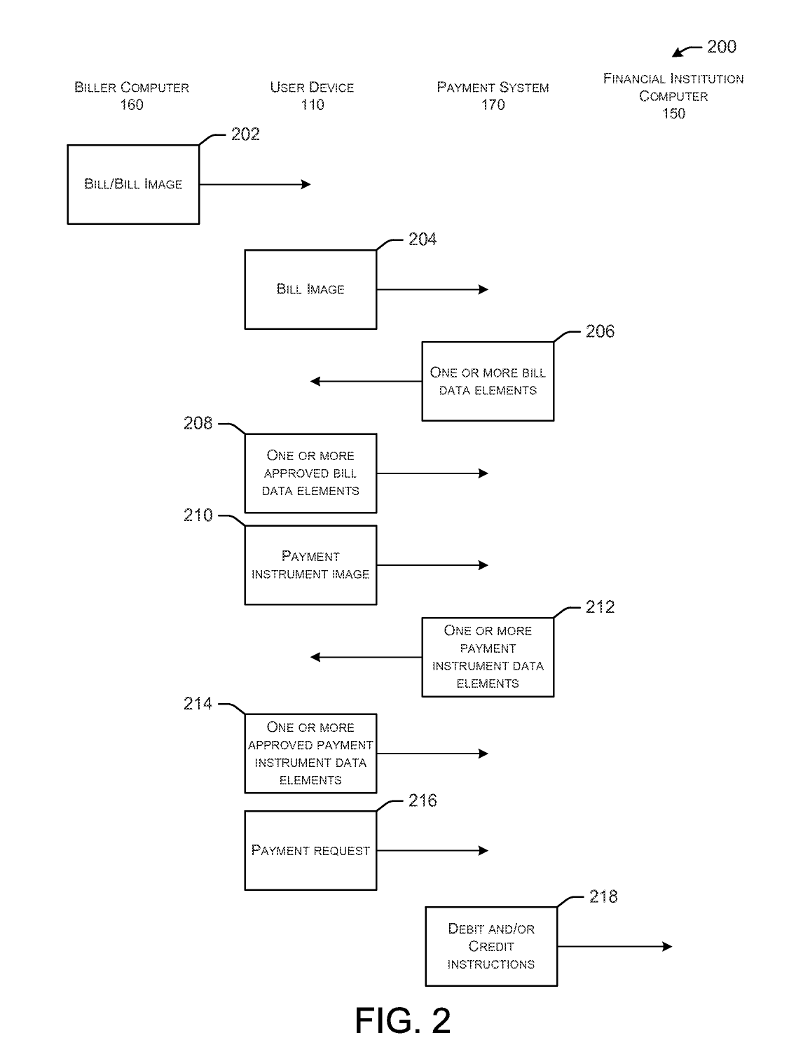

Referring now to FIG. 2, a simplified schematic diagram illustrating example interactions between the various entities of architecture 100 in accordance with embodiments of the disclosure is discussed. In one aspect, the interactions as shown herein may effectuate a bill payment from the payer 102 to the biller. As illustrated in block 202, a bill and/or bill image may be transmitted from the biller computer 160 or the biller to the user device 110. In some cases, the bill image may be transmitted in a digital format via electronic transmission, such as via networks 140. In other cases, a bill printed on paper may be sent to the payer 102 using a variety of physical delivery mechanisms, such as though the mail, and the payer 102 uses the user device 110 to capture an image of at least a portion of the paper bill. In the case of receiving a bill image, the user device 110 may optionally store the bill image in memory 130.

At block 204, a bill image may be transmitted by the user device 204 to the payment system 170 via the networks 140 or other suitable communicative connections. If this bill image was received by the user device 110 in digital form from the biller computer 160, then the bill image may be transmitted from user device 110 in the received form to the payment system 170. Alternatively, the bill image may be altered by any variety of image processing mechanisms by the user device 110 prior to transmission to the payment system 170. The captured bill image may then be stored in memory 130 and/or transmitted to the payment system 170 or other entity.

The payment system 170 may receive the bill image and based at least in part on the bill image, determine one or more bill data elements at block 206 and transmit those bill data elements, or indications thereof, to the user device 110. Determining the bill data elements may entail image processing and/or text recognition processes. The transmission of the one or more bill data elements may be via the networks 140 or other suitable communications connections.

Next, at block 208, the user device 110 may determine one or more approved bill data elements and transmit those to the payment system 170. Generating and/or identifying the one or more approved bill data elements may entail soliciting input by the user device 110 from the payer 102 on approval or modification of the received one or more bill data elements. These solicitations and interactions with the payer 102 may be performed via the one or more I/O components 112, 114, 116 of the user device 110.

At block 210, a payment instrument image of a payment instrument or a portion thereof, may be captured or accessed from memory 130 or other storage location by the user device 110 and transmitted to the payment system 170 via the networks 140 or other suitable communications connections.

At block 212, one or more payment instrument data elements may be transmitted by the payment system 170 to the user device 110. The payment instrument data elements may be determined based at least in part on the payment instrument image received by the payment system 170. The payment system 170 may perform a variety of image processing algorithms and or text recognition algorithms to ascertain the one or more payment instrument data elements.

At block 214, the user device 110 may determine one or more approved payment instrument data elements and transmit those to the payment system 170. Generating and/or identifying the one or more approved payment instrument data elements may entail soliciting input by the user device 110 from the payer 102 on approval or modification of the received one or more payment instrument data elements. These solicitations and interactions with the payer 102 may be performed via the one or more I/O components 112, 114, 116 of the user device 110.

At block 216, the user device 110 may provide the payment system 170 with a payment request. The payment request may include an indication of the payer's desire to execute the bill payment of the bill with the payment instrument. In some cases, the payment request may be generated and transmitted by the user device based at least in part on input or approval from the payer 102. In the same or other cases, the payment request may be generated and transmitted based at least in part on a proposed payment provided by the payment system 170 to the user device 110.

At block 218, the payment system may provide credit and/or debit instructions to one or more financial institution computers to execute the bill payment in accordance with the payment request.

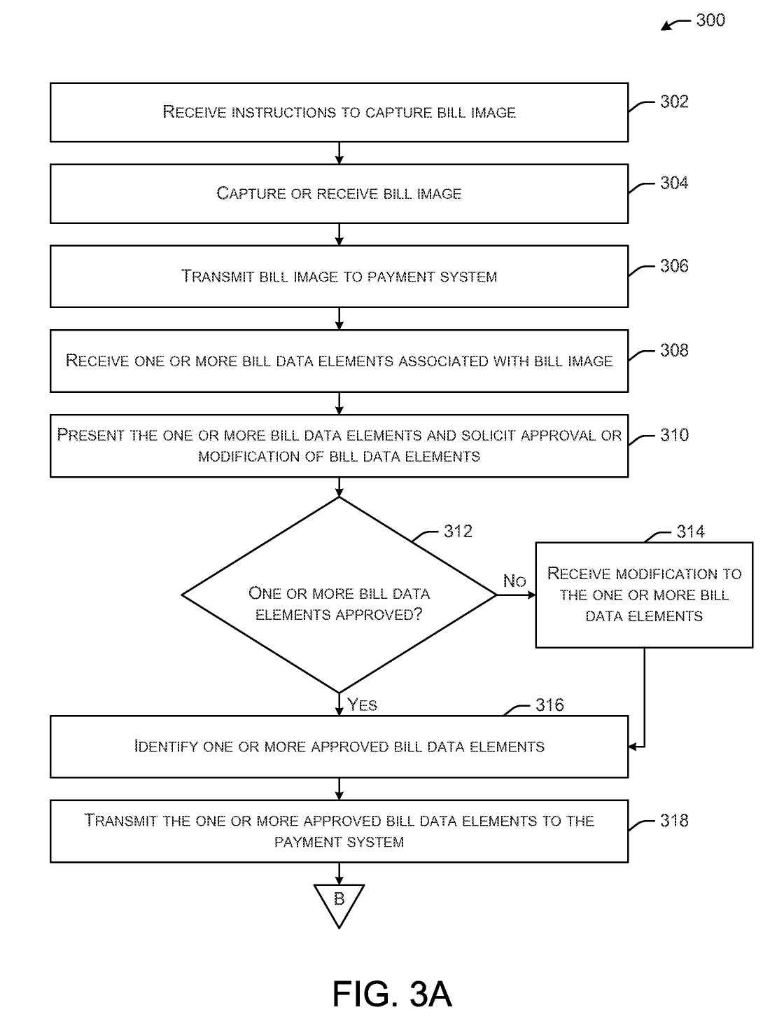

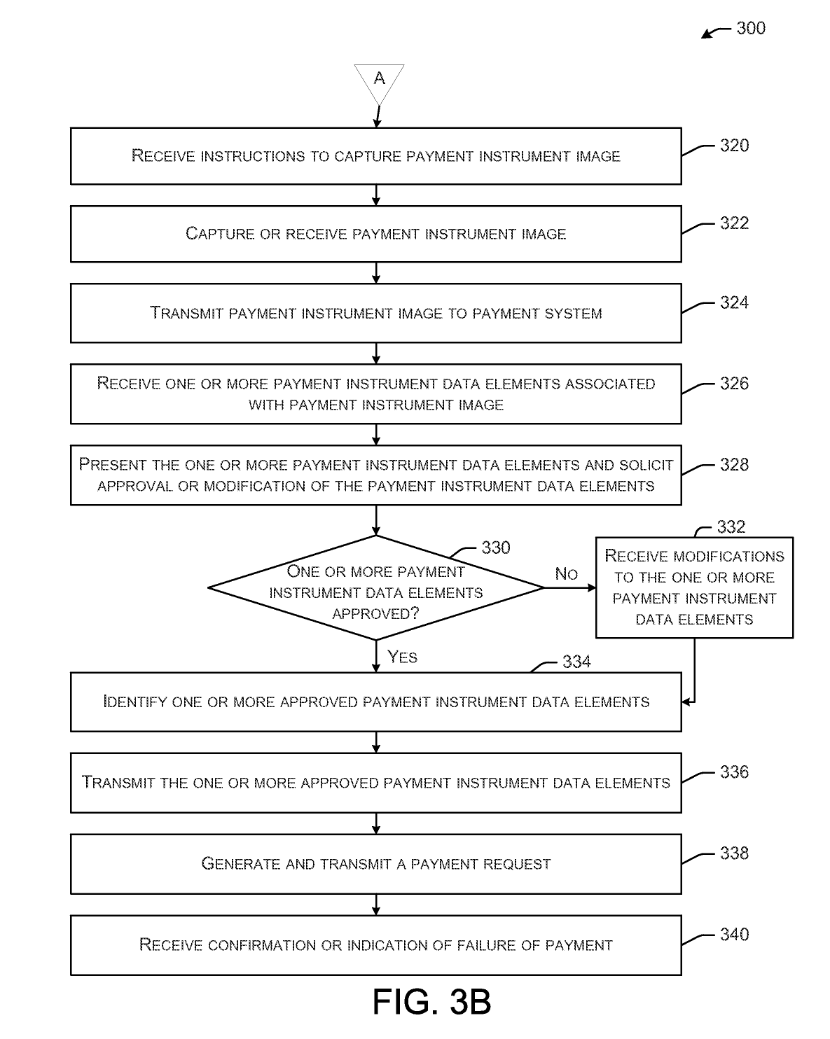

Referring now to FIGS. 3A and 3B, an example method 300 performed by the user device 110 in accordance with embodiments of the disclosure to effect a bill payment are described. Method 300, in certain embodiments, may be performed by the user device 110 interacting with one or more other entities of the architecture 100 such as a corresponding respective payer 102 and a payment system 170.

At block 302, instructions to capture a bill image may be received and/or retrieved. The instructions may be rendered to the payer 102 associated with the user device 110 such as via the display 112 or a microphone of the user device or any other suitable I/O component 112, 114, 116. The instructions may, in certain embodiments, be received from the payment system 170 and may instruct the payer 102 of which parts of a bill may be included in the bill image. Alternatively, the instructions associated with capturing the bill image may be stored locally on the user device 110, such as on the memory 130. As an example, the bill instructions may provide instructions to capture an image of a bill payment coupon. The process of block 302 may be optional in certain embodiments where the bill image may be received by the user device 110 directly from the biller computers 160, such as in digital form via the networks 140 or other suitable communicative connections.

At block 304, the bill image may be captured or received. The receiving may be via the network 140 from one or more of the biller computers 160 corresponding to the particular billing entity. For example, an electronic bill image for an electricity bill may be received from a power company providing the electricity to a consumer, such as the payer. In capturing the bill image, an image sensor 116 may be used by the user device 110, the processors 120 thereon, and/or the payer 102 to capture the bill image. The image scanner 116 may be in a variety of forms, including, but not limited to, a web cam, a digital camera, a linear CCD scanner, a flatbed image scanner, a handheld image scanner, a combination scanner, facsimile, printer and/or copier. In certain embodiments, the captured or received bill image may be electronically stored, such as on the memory 130 of the user device 110. In some cases, the bill image may be received via a third intermediary, such as from a server, to which the bill image was previously uploaded.

At block 306, the bill image may be transmitted to the payment system. The transmission may be via the networks 140 or any suitable communicative connection between the user device 110 and the payment system 170. In certain embodiments, the transmitted bill image may be encrypted or otherwise transmitted over a secure communicative link between the user device 110 and the payment system 170. In certain further embodiments, the bill image may be uploaded to a website that is either served by the payment system 170 or accessible by the payment system 170 to retrieve the bill image. In some cases, if a mechanism of uploading to a website is used for the transmission of the bill image to the payment system 170, the connection to the website may be encrypted or otherwise secure by any variety of mechanisms, such as by using secure socket layer (SSL).

At block 308, one or more bill data elements, or indications thereof, associated with the bill image may be received. The bill data elements may be received from the payment system 170 via the networks 140 or other suitable communicative connections. The bill data elements may be ascertained by the payment system 170 based at least in part on the bill image. Alternatively, the bill data elements may be ascertained by the user device 110 and the processors 120 thereon by applying any variety of image processing and/or character recognition algorithms to the bill image. In some embodiments, image improvement processing may be performed just prior to block 308, either at the user device 110 or at the payment system 170 or both the user device 110 and payment system 170.

At block 310, the one or more bill data elements may be presented to the payer and an approval or modification of the bill data elements may be solicited. In one aspect, the one or more bill data elements may be presented via one or more I/O components 112, 114, 116, such as on the display 112. The approval solicitation may entail directing the payer to review the one or more bill data elements and click on an approval and/or confirmation button rendered on the display 116 to effectuate approval. The user device 110 may further solicit any changes to the one or more bill data elements by allowing the payer 102 to enter new values for one or more of the one or more bill data elements.

At block 312, it may be determined if an approval of the one or more bill data elements was received. If an approval was not received, then modifications to at least one of the one or more bill data elements may be received at block 314, such as by payer input 102 via one or more I/O components 112, 114, 116. Upon receiving either the approval or new values for at least one of the one or more bill data elements from the payer 102, the user device may identify one or more approved bill data elements at block 316. In the case of the received one or more bill data elements being approved at block 312, the one or more approved bill data elements may be the same as the one or more bill data elements received at block 308. Otherwise, at least one element of the one or more approved bill data elements may be different from the one or more bill data elements received at block 308. At block 318, the one or more approved bill data elements, or indications thereof, may be transmitted to the payment system via the networks 140 or other suitable communicative connections.

At block 320, instructions to capture a payment instrument image may be received and/or retrieved. The received instructions may be rendered to the payer 102 associated with the user device 110 such as via the display 112 or a microphone of the user device or any other suitable I/O component 112, 114, 116. The instructions may, in certain embodiments, be received from the payment system 170 and may instruct the payer 102 of which parts of a payment instrument may be included in the payment instrument image. Alternatively, the instructions associated with capturing the payment instrument image may be stored locally on the user device 110, such as on the memory 130. As an example, the payment instrument instructions may provide instructions to capture an image of front side of a check. As another example, the payment instructions may provide instructions to capture an image of both the front side and the back side of a credit card in cases where the CVV may be on the backside of the credit card.

In certain embodiments, the payment instrument image may have previously been captured and processed, and either the payment instrument image or extracted element may have been stored on the user device or at a remote location, such as in memory 130 or at the payment system 170. In these embodiments, the process of block 320 may be optional and instead, the payment instrument image or associated data elements may be received by the user device 110 directly from where the payment instrument image may be stored.

It should be noted that in certain embodiments, a payer 102 may be enrolled and his/her funding account information may already be captured using the image processing methods disclosed herein and may be stored in association with the payer 102 in a data repository. That could be within the payment system in at some independent location. In effect, this may be similar to population of an electronic “wallet” from a payment instrument image. The wallet may be specific to the payment system 170 or may be usable across a variety of payment applications.

At block 322, the payment instrument image may be captured or received. The receiving may be from wherever the payment instrument image was stored. For example, an electronic payment instrument image may be retrieved by the processors 120 from the memory 130. In capturing the payment instrument image, an image sensor 116 may be used by the user device 110, the processors 120 thereon, and/or the payer 102 to capture the payment instrument image. In certain embodiments, the captured or received payment instrument image may be electronically stored, such as on the memory 130 of the user device 110.

At block 324, the payment instrument image may be transmitted to the payment system. The transmission may be via the networks 140 or any suitable communicative connection between the user device 110 and the payment system 170. In certain embodiments, the transmitted payment instrument image may be encrypted or otherwise transmitted over a secure communicative link between the user device 110 and the payment system 170. In certain further embodiments, the payment instrument image may be uploaded to a website that is either served by the payment system 170 or accessible by the payment system 170 to retrieve the payment instrument image. In some cases, if a mechanism of uploading to a website is used for the transmission of the payment instrument image to the payment system 170, the connection to the website may be encrypted or otherwise secured by any variety of mechanisms, such as by using secure socket layer (SSL).

At block 326, one or more payment instrument data elements, or indications thereof, associated with the payment instrument image may be received. The payment instrument data elements may be received from the payment system 170 via the networks 140 or other suitable communicative connections. The payment instrument data elements may be ascertained by the payment system 170 based at least in part on the payment instrument image. Alternatively, the payment instrument data elements may be ascertained by the user device 110 and the processors 120 thereon by applying any variety of image processing and/or character recognition algorithms to the payment instrument image. In certain embodiments, a text string or logo associated with the financial institution corresponding to the account number (or portion thereof, like the RTN) may be received and displayed. This may enhance the user experience and payer 102 confidence in the system.

At block 328, the one or more payment instrument data elements may be presented to the payer and an approval or modification of the payment instrument data elements may be solicited. In one aspect, the one or more payment instrument data elements may be presented via one or more I/O components 112, 114, 116, such as on the display 112. The approval solicitation may entail directing the payer to review the one or more payment instrument data elements and click on an approval and/or confirmation button rendered on the display 116 to effectuate approval. The user device 110 may further solicit any changes to the one or more payment instrument data elements by allowing the payer 102 to enter new values for one or more of the one or more payment instrument data elements.

At block 330, it may be determined if an approval of the one or more payment instrument data elements was received. If an approval was not received, then modifications to at least one of the one or more payment instrument data elements may be received at block 332, such as by payer input 102 via one or more I/O components 112, 114, 116. Upon receiving either the approval or new values for at least one of the one or more payment instrument data elements from the payer 102, the user device 110 may identify one or more approved payment instrument data elements at block 334. In the case of the received one or more payment instrument data elements being approved at block 330, the one or more approved payment instrument data elements may be the same as the one or more payment instrument data elements received at block 326. Otherwise, at least one element of the one or more approved payment instrument data elements may be different from the one or more payment instrument data elements received at block 326. At block 336, the one or more approved payment instrument data elements, or indications thereof, may be transmitted to the payment system via the networks 140 or other suitable communicative connections.

At block 338, a payment request may be generated and transmitted. This payment request may indicate the payer's intention to make a bill payment based at least in part on the one or more approved bill data elements and the one or more approved payment instrument data elements. This payment request, in certain embodiments, may be generated responsive to presenting the payer 102 with a proposed bill payment transaction and the payer 102 approving the proposed bill payment transaction. The payment request may be transmitted by the user device 110 to the payment system 170 via the networks 140 or other suitable communicative connection. At block 340, a confirmation, such as an indication that the payment request was accepted for processing, or indication of failure of payment may be received. If the payment was successfully made, then the user device 110 may receive a confirmation of the bill payment from the payment system 170. If the payment did not transpire, for any variety of reasons, such as inability to debit or credit a financial account, then an indication of failure of the bill payment may be received by the user device 110 from the payment system 170.

It should be noted, that the method 300 may be modified in various ways in accordance with certain embodiments of the disclosure. For example, one or more operations of the method 300 may be eliminated or executed out of order in other embodiments of the disclosure. Additionally, other operations may be added to the method 300 in accordance with other embodiments of the disclosure.

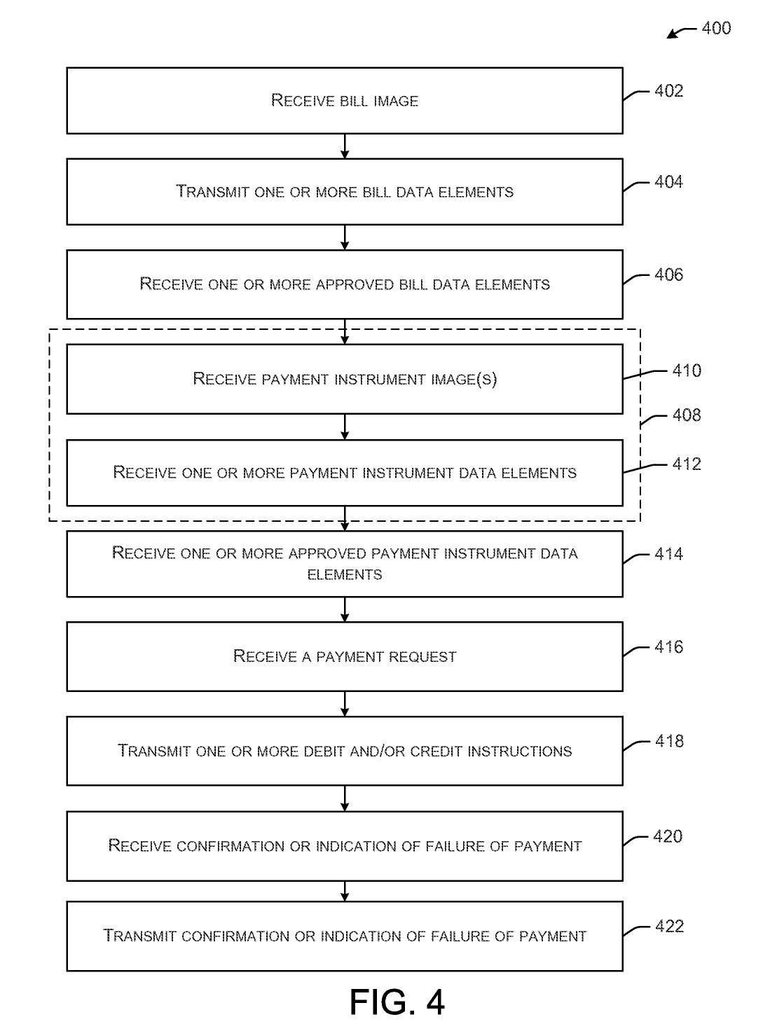

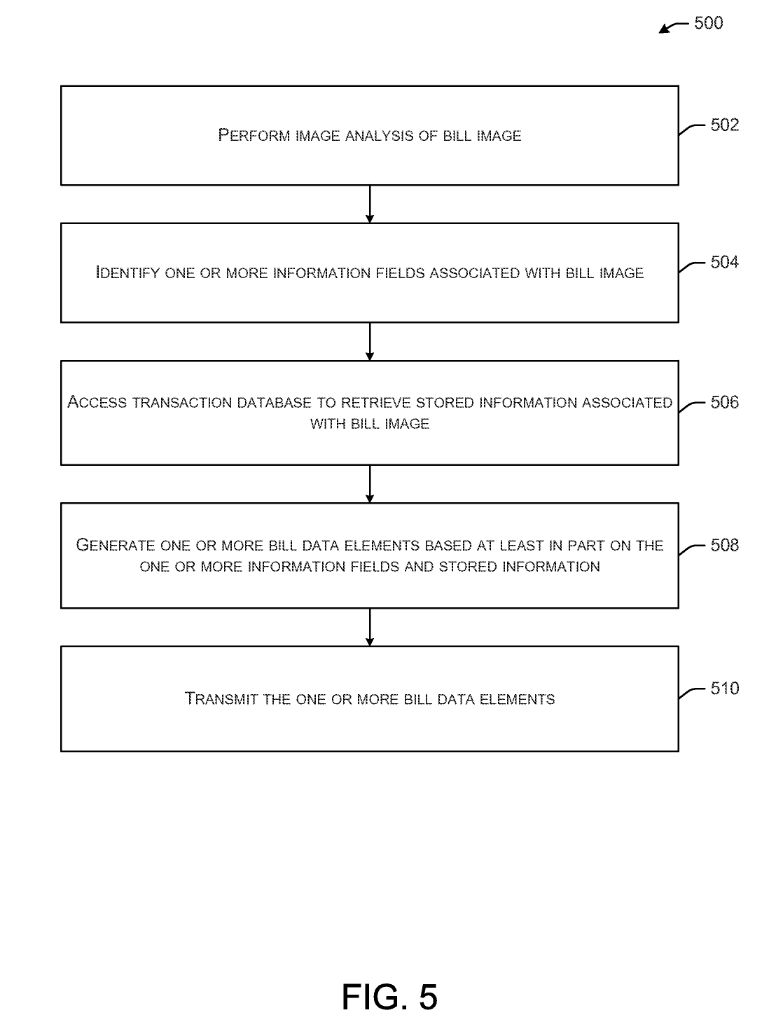

Referring now to FIG. 4 an example method 400 performed by the payment system 170 for bill payment in accordance with embodiments of the disclosure is discussed. In certain embodiments, the method 400 may be performed by the payment system 170 with interaction with other entities of the architecture 100, such as user devices 110 and the financial system computers 150. At block 402, a bill image may be received. The bill image may be received from the user device 110 and may be an image of a bill, or a portion thereof, to be paid by the payer 102 associated with the user device 110 from which the bill image is received. At block 404, one or more bill data elements may be transmitted. The bill data elements may be determined using a variety of techniques based at least in part on the received bill image. The determination of the bill data elements from the bill image is discussed in greater detail below in conjunction with FIG. 5. The one or more bill data elements may be transmitted to the user device 110 via the networks 140 or other suitable communicative connections. At block 406, one or more approved bill data elements may be received. These one or more approved bill data elements may be the same or different from the bill data elements transmitted at block 404, depending on whether the payer had made any changes to the one or more bill data elements. The one or more approved bill data elements may be received from the user device 110 and the identification of the one or more approved bill data elements is discussed in conjunction with blocks 312, 314, and 316 of method 300 of FIGS. 3A and 3B.

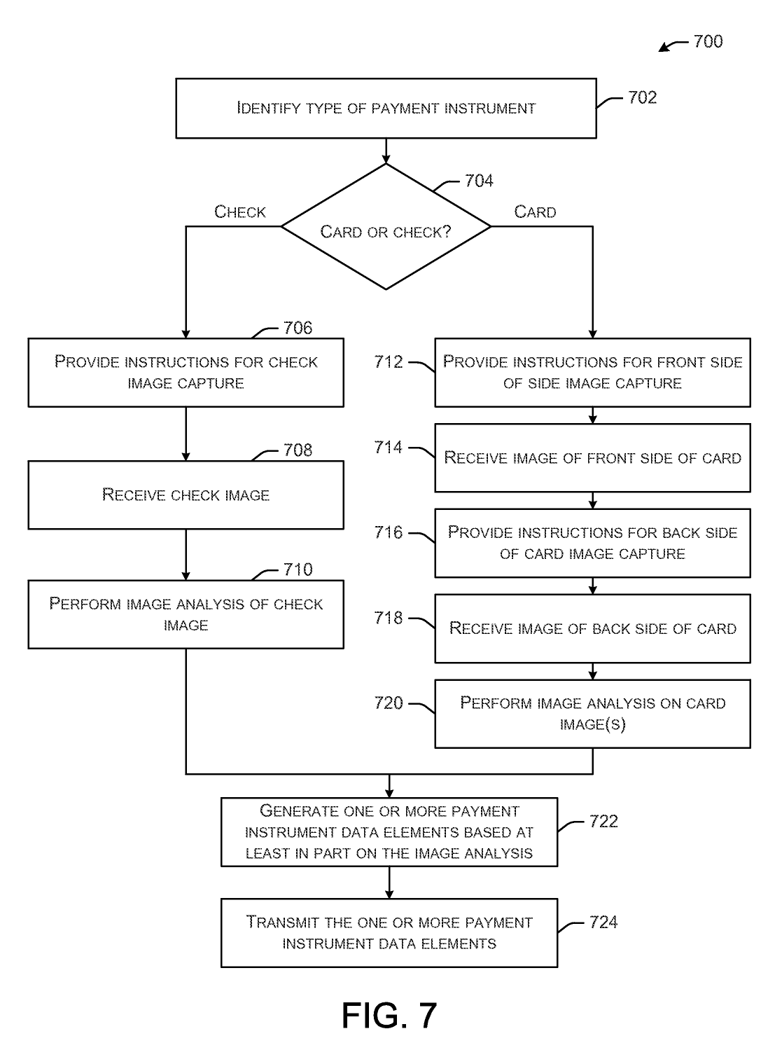

At block 408, one or more payment instrument image(s) may be received and (block 410) and one or more payment instrument data elements may be transmitted (block 412). The one or more payment instrument image(s) may be received from the user device 110 and the one or more payment instrument data elements may be transmitted to the user device 110. The payment instrument data elements may be determined using a variety of techniques based at least in part on the received bill image. Greater details of receiving the payment instrument image(s) and transmitting the one or more payment instrument data elements is discussed in conjunction with FIG. 7 below. At block 414, one or more approved payment instrument data elements may be received. These one or more approved payment instrument data elements may be the same or different from the payment instrument data elements transmitted at block 412, depending on whether the payer had made any changes to the one or more payment instrument data elements. The one or more approved payment instrument data elements may be received from the user device 110 and the identification of the one or more approved payment instrument data elements is discussed in conjunction with blocks 330, 332, and 334 of method 300 of FIGS. 3A and 3B.

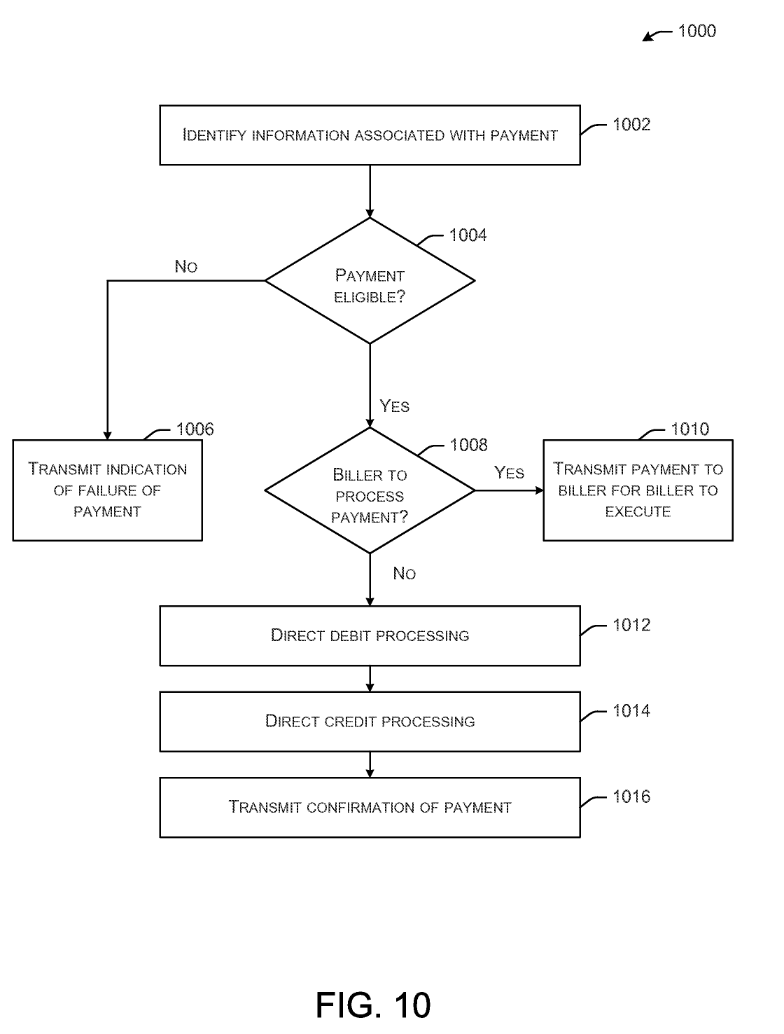

At block 416, a payment request may be received. The payment request may be received from the user device and may be indicative of a payer's request to pay a bill based at least in part on the approved bill data elements and the approved payment instrument data elements. In certain embodiments, the payment instrument elements and/or payment request may be stored such as on memories 180 or other suitable storage location. At block 418, one or more debit and/or credit instructions may be generated and transmitted, for example to any variety of payment networks and/or financial institutions, to perform the bill payment associated with the payment request. The debit and/or credit instructions may be transmitted to one or more financial institution computers 150 via the networks 140 or other suitable communicative connections. The credit and debit processing is described in greater detail in conjunction with FIG. 10. At block 420, a confirmation of the bill payment or an indication of failure of the bill payment may be received. The confirmation or indication of failure may be received form the one or more financial institution computers 150 to which credit and/or debiting instructions were sent at block 418. In some embodiments, the indication of failure of the transaction may include one or more reasons for failure of the transaction, such as insufficient funds and/or insufficient credit available. At block 422, the confirmation or indication of payment may be transmitted. In some cases, this confirmation may not be dependent on receiving any notification of success or failure from a payment network or FI. Indeed, it may be transmitted to simply indicate confirmation of the validity of the payment request or confirmation of initiating appropriate debit and credit instructions.

It should be noted, that the method 400 may be modified in various ways in accordance with certain embodiments of the disclosure. For example, one or more operations of the method 400 may be eliminated or executed out of order in other embodiments of the disclosure. Additionally, other operations may be added to the method 400 in accordance with other embodiments of the disclosure.

Referring now to FIG. 5 an example method 500 for transmitting bill data elements associated with a bill in accordance with embodiments of the disclosure is discussed. In certain embodiments, this method 500 may be performed by the payment system 170. Method 500 may be an example of process 404 of method 400 of FIG. 4. At block 502, image analysis and/or image improvement may be performed on the bill image. The image analysis may entail image filtering, image sharpening, modifying an image orientation, modifying the dithering of one or more pixels of the image, modifying the contrast of the image, modifying the brightness of the image, processing metadata associated with the image, image field recognition, text sequence recognition, optical character recognition, intelligent character recognition, or the like.

At block 504, one or more information fields associated with the bill image may be identified, such as by image analysis. This identification may be based at least in part on the image analysis performed at block 502. In other words, particular text and/or locations on the bill image may be recognized by the payment system 170. For example, the words “Total Due” may be recognized as a field that may have a payment amount in close proximity on the field, such as to the right of the field. Therefore, data may be extracted from the bill image based on the identified fields on the bill image. In the same or other embodiments, the data extraction may be based on specific field locations and/or dimensions.

At block 506, stored information associated with the bill image may be accessed. The stored information, in one aspect, may be accessed from a database and/or a look up table such as one stored in memory 180 or transaction database 190. In certain embodiments, the stored information that may be accessed may include a record of transactions associated with particular payers 102 and/or particular billers. Therefore the payment system 170 may be able to ascertain whether a particular bill has already been paid by accessing the stored information. In the same or different embodiments, the payment system may be able to access a financial account number associated with a particular biller based on information detected on a bill image. By accessing this account information, the payment system 170 may be able to direct a credit instruction to a financial account associated with the biller. In other embodiments, the payment system 170 may be configured to mail a payment, such as a check, to a remittance center associated with the biller. In certain embodiments, some or all of the stored information may not be accessible to the payer 102. For example, the payment system 170 may not provide the biller's financial account information to the payer 102. The process of block 506 may be optional in certain embodiments. In these embodiments, stored transaction data may not be accessed associated with the bill image to process a bill payment.

At block 508, one or more bill data elements may be generated based at least in part on the one or more information fields and optionally stored information. The one or more bill data elements may include an identification of the biller, an identification of the biller's address, an identification of the biller's payment address (if different from the biller address), an identification of the biller's telephone number, an identification of a consumer, an identification of the consumer's account number, an identification of the consumer's address, an invoice number, a payment due date, a payment amount, or the like. At block 510, the one or more bill data elements may be transmitted. The transmission may be to the user device 110 for presentation to the payer 102 via the networks 140 or other suitable communicative connections. In certain embodiments, some of the one or more bill data elements may not be transmitted to the user device 110. For example, biller account related information may not be shared with the payer 102 via transmission to the user device 110. As another example, biller address and/or phone number information may not be communicated to the payer 102 if the biller is recognized as a “managed payee” and the payment system 170 may, in fact, have more accurate and/or alternative information for the biller.

It should be noted that the method 500 may be modified in various ways in accordance with certain embodiments of the disclosure. For example, one or more operations of the method 500 may be eliminated or executed out of order in other embodiments of the disclosure. Additionally, other operations may be added to the method 500 in accordance with other embodiments of the disclosure.

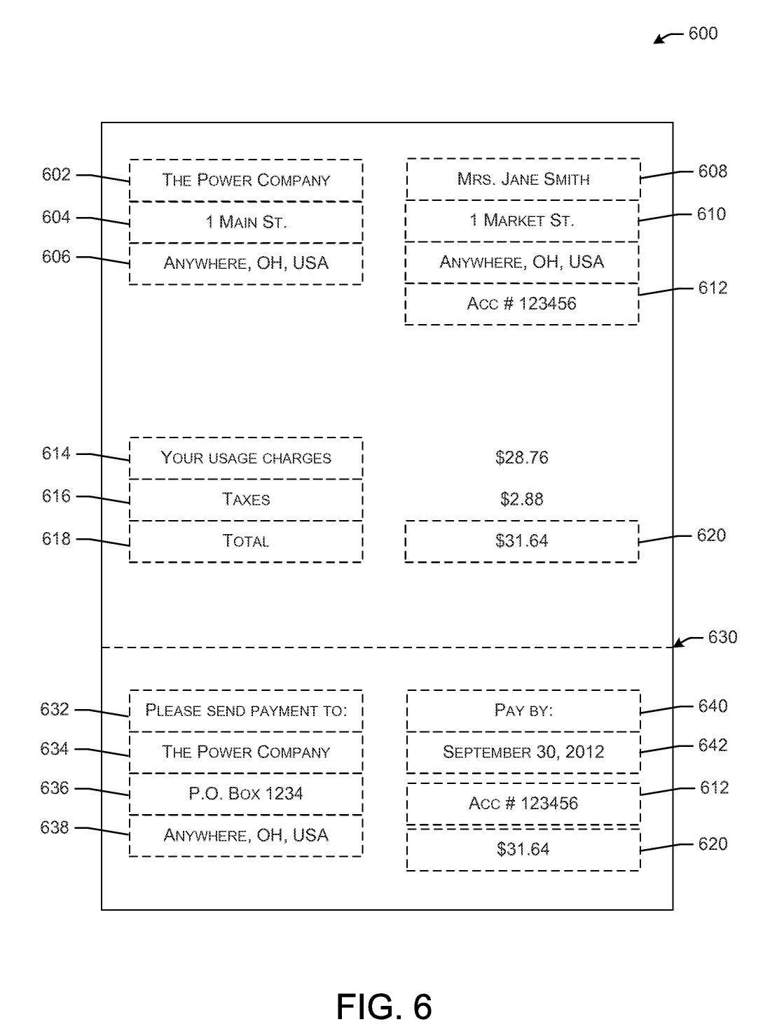

Referring now to FIG. 6 an example image of a bill with bill data elements identified in accordance with embodiments of the disclosure is discussed. As shown on this example bill image 600, fields corresponding to a biller's identification 602, biller address 604, 606, consumer's name 608, consumer's address 610, consumer's account number 612, indication of subtotal of charges 614, 616, 618, minimum amount due (not shown), and total charges 620 may be determined. In some cases, a bill payment coupon 630 may be utilized by the payment system 170 and fields thereon may be identified. In certain embodiments, one or more fields, may be obtained from the payment coupon 630. For example, fields 632, 634, 636, 638 associated with identifying a billing address, fields associated with identifying a payment date 640, 642, and fields associated with the payment amount 620 and account number 612 may be identified. Once the various fields on the bill are identified, the one or more bill data elements may be determined. As shown in this example, biller's name, biller's address, consumer's name, consumer's address, payment amount, payment address, and payment due date may be ascertained.

Referring now to FIG. 7, an example method 700 for providing one or more payment instrument data elements in accordance with embodiments of the disclosure is described. The method 700, in certain embodiments, may be performed by the payment system 170 and may be an example of process 408 of method 400 of FIG. 4. At block 702, the type of payment instrument may be identified. In certain embodiments, the type of payment instrument may be ascertained by the payment system 170 transmitting a question asking the type of payment instrument to the user device 110 and receiving a response indicating the type of the payment instrument. This response may be based at least in part on a payer input and/or interaction with the user device 110. In this case, the user device may pose the question of the type of payment instrument to the payer via one or more I/O components 112, 114, 116 and receive a response indicative of the payment instrument from the payer via the same or different I/O components 112, 114, 116.

At 704, it may be determined if the payment instrument is a card, such as a debit, credit, or prepaid card, or a check. This may be determined based on the identification at block 702. If the payment instrument is a check, then at block 706 instructions for check image capture may be transmitted. These instructions may be transmitted to the user device 110 via the networks 140 or other suitable communicative connections. At block 708, a check image may be received. This check image may be received form the user device 110 and at block 710 image analysis Therefore, generic image improvement, as well as image analysis may be performed. may be performed on the check image. The image analysis may be performed, in certain aspects, to be able to extract information from the check image that can be used to effect a payment using a financial account associated with the check image. The image analysis, in certain embodiments, may be used to repair any defects in the received check image. For example, if the received check image has a lot of noise, or otherwise spots and/or streaks thereon, then filtering and/or dithering techniques may be used to reduce the level of noise in the image. As another example, if the image is skewed, or otherwise trapezoidal rather than rectangular, due to the angle of the image sensor relative to the check while the check image was captured, then various techniques may be used to reduce the trapezoidal effect. The image analysis may also be used to recognize text on the check image. Therefore, the image analysis techniques may include, but are not limited to, image filtering, image sharpening, modifying an image orientation, modifying the dithering of one or more pixels of the image, modifying the contrast of the image, modifying the brightness of the image, processing metadata associated with the image, image field recognition, text sequence recognition, optical character recognition, intelligent character recognition, or combinations thereof.

At block 704, if it was determined that the payment instrument is a card, then the method 700 may proceed to block 712, where instructions may be provided for capturing an image of the front side of the card. These instructions may be transmitted to the user device 110 via the networks 140 or other suitable communicative connections. At block 714, an image of the front side of the card may be received. Optionally, if an image of the back side of the card is needed for executing the payment transaction, then at block 716, instructions may be provided for capturing an image of the back side of the card. The back side may be needed in cases where there may be important transaction information on the back side of the card, such as the CVV. At block 718, optionally, an image of the backside of the card may be received. At block 720 image analysis may be performed on the card image(s) using techniques similar to those described in conjunction with the check image at block 710. Image improvement to enhance the image of the backside of the card may also be performed.

At block 722, one or more payment instrument data elements may be generated based at least in part on the image analysis. The payment instrument data elements may be associated with either the card or the check. For example, check related payment instrument data elements may include an identification of a payment instrument type, an identification of the payer's address, an identification of the payer's telephone number, an identification of a routing number, an identification of a financial institution, an identification of a financial account number, an identification of a check number, or combinations thereof. Card related payment instrument data elements may include an identification of a payment instrument type, an identification of a financial institution, an identification of a financial account number, an expiration date, a card verification value (CVV), or combinations thereof. At block 724, the one or more payment instrument data elements may be transmitted. In certain embodiments, the one or more payment instrument data elements may be transmitted by the payment system 170 to the user device 110 via the networks 140 or other suitable communicative connections.

It will be appreciated that in certain alternate embodiments, the payment system 170 may ascertain the payment instrument type based at least in part on the received payment instrument image. For example, the payment system may be able to distinguish between a check, a credit card, a debit card, or a prepaid card based at least in part on the received payment instrument image. In certain embodiments, the payment system 170 may be able to determine that the payment instrument is not a particular payment type, but may not be able to narrow down to a single payment type based on a first analysis of the payment instrument image. In these embodiments, the payment system may not ascertain which payment type is to be used prior to providing instructions for capturing the image of the payment instrument. Indeed, instructions may be provided for multiple payment type and upon receiving the payment instrument image from the user device 110 the payment system may ascertain the payment instrument type by analyzing the image and data fields and payment instrument data elements thereon. For example, if the payment system 170 detects a routing number, then payment system 170 may determine that the payment instrument image is associated with a check. On the other hand, if the payment system detects a particular credit card number, then the payment system 170 may determine that the payment instrument image is associated with a credit card.

It should be noted, that the method 700 may be modified in various ways in accordance with certain embodiments of the disclosure. For example, one or more operations of the method 700 may be eliminated or executed out of order in other embodiments of the disclosure. Additionally, other operations may be added to the method 700 in accordance with other embodiments of the disclosure.

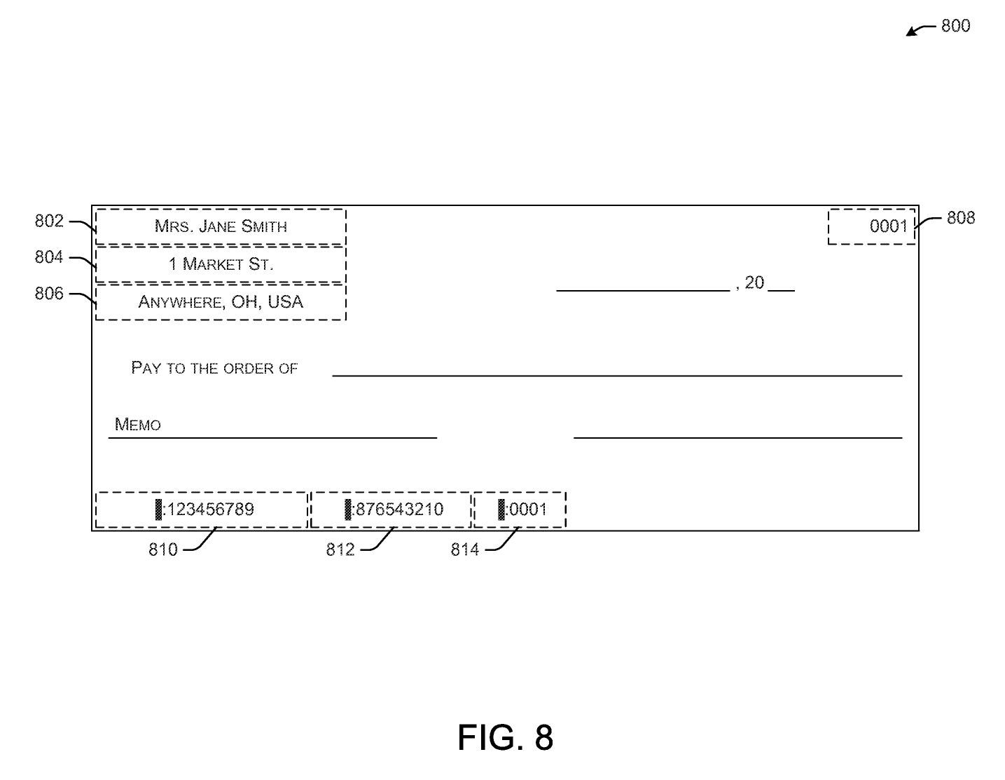

Referring now to FIG. 8, an example image of a payment instrument 800 with payment instrument data elements identified in accordance with embodiments of the disclosure is described. The payment instrument associated with the payment instrument image 800 may be a check. Fields corresponding to the payer's identification 802, payer's address 804, 806, and check number 808 may be identified. Further fields associated with magnetic ink character recognition (MICR), such as a routing number 810, an account number 812, and the check number 814 may be identified.

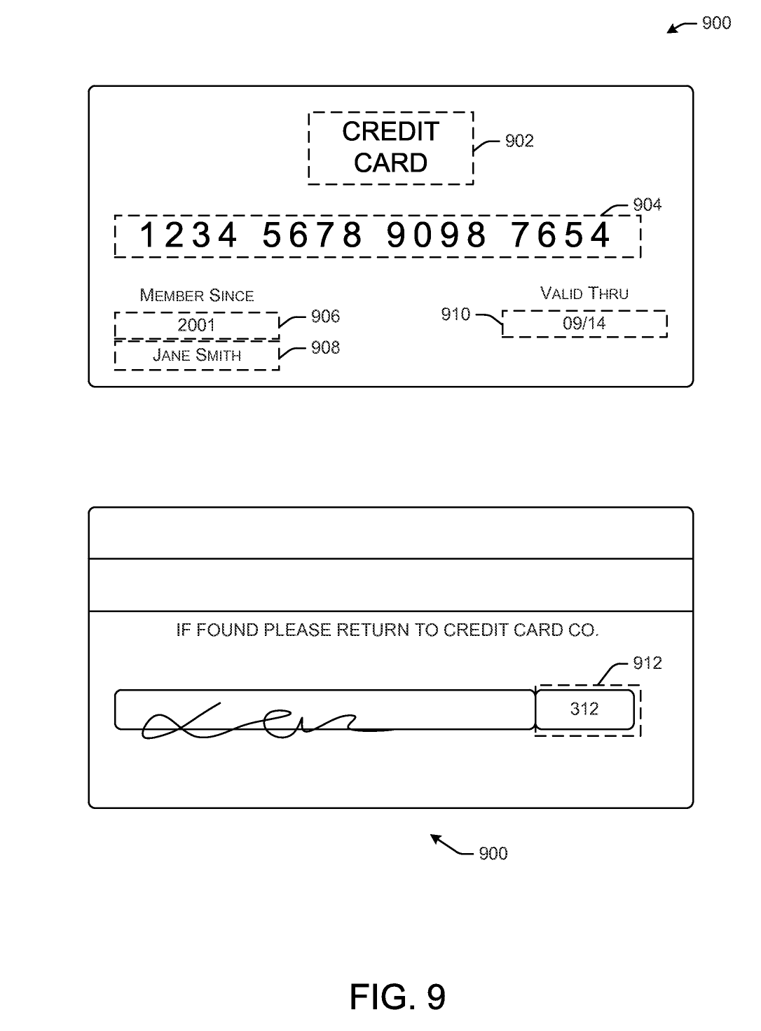

Referring now to FIG. 9 another example image of a payment instrument 900 with payment instrument data elements identified in accordance with embodiments of the disclosure is described. The payment instrument associated with the payment instrument image 900 may be a credit card. Fields corresponding to a credit card association or issuer identification 902, an account number 904, a member since date 906, the payer's identification 908, a payment instrument expiration date 910, and a CVV 912, or other security code may be identified. It will be noted that in some cases the security code or CVV may be on the front side of the credit card. It will be appreciated that in this case the payment instrument image(s) includes both the front side of the credit card 900 and the back side of the credit card 900. The back side may be needed in this case, since the CVV 912 is shown on the back side of the credit card 900. However, for certain credit cards, where the CVV may be shown on the front side, such as credit cards issued by American Express®, only an image of the front side of the credit card 900 may be needed to ascertain all the information for processing a bill payment in accordance with embodiments of the disclosure.

Referring now to FIG. 10 an example method 1000 for directing a bill payment in fulfillment of a payment request in accordance with embodiments of the disclosure is described. The method 1000 may be performed by the payment system 170 interacting with one or more of the financial institution computers 150 through one or more payment networks. At block 1002, information associated with a payment request may be identified. The information may be ascertained based at least in part on the payment request received at block 416 of method 400. The information identified may be information that is needed for effecting the transaction. Indeed, some or all of the information acquired as part of the bill data elements and the payment instrument data elements may be part of the information associated with the payment. For example, the information may include, but is not limited to, the payer's financial account number, the billers account number, the bill amount, the payment due date, or the like.

At block 1004, it may be determined if the payment request is eligible for processing. Eligibility may be determined by ascertaining if there are enough funds and/or credit available in the payer's account or if the payment request satisfies risk analysis. Such risk analysis may be based on one or more attributes of the payment request (e.g., the payment amount) or a prior history of financial transaction activity (e.g., prior financial transactions associated with the payer). Other risk analysis may leverage 3^{rd}-party information sources, such as credit bureaus. In certain embodiments, the payment request may be ineligible if the funding account is determined to not exist or be in other than an active state. In certain embodiments, the payment system 170 may also check if the payment request is a duplicate of one that has already been processed earlier, in case the payer may have forgotten about the earlier transaction. If it is determined that the payment request is not eligible at block 1004, then at block 1006, an indication of failure of processing the payment request may be transmitted. This transmission from the payment system 170 to the user device 110, in certain embodiments, may include a reason for failure. At block 1004, if it is determined that the payment request is eligible, then at block 1008, it may be determined if the biller is to process the payment request directly. This determination may be made by the payment system 170 by communicating with at least one of the payer 102 via the user device 110 or with the biller computers 160. In certain embodiments, the determination may be made as an internal decision of the payment system based on contractual relationship with the biller and biller preference If it is determined that the biller is to process the payment request at block 1008, then at block 1010 the payment, or information required to generate and/or execute the payment may be transmitted to the biller. It will be appreciated that the processes of blocks 1008 and 1010 may be optional and that in certain embodiments, the biller may not process the payment request. Note that this may be performed with the cooperation of the biller (via transmission of the payment request in a protocol that the biller can receive and process), or may be performed without the biller's cooperation, such as by “payment tunneling” where payment system 170 logs into the biller's Web site on behalf of the payer, navigating to the appropriate Web page for submitting a payment, filling the Web page for the payer, and submitting the payment.

At block 1008, if it is determined that the payment system is to direct the payment, then at block 1012, the payment system 170 may direct debit processing associated with the bill payment. In one aspect, an amount may be debited from the financial account associated with the payment instrument. In some cases, the debit amount may be the bill payment amount. In other cases, the debit amount may be different from the bill payment amount. In other embodiments, a paper draft to the payee drawn on the financial account associated with the payment instrument may be issued. At block 1014, the payment system 170 may direct credit processing associated with the bill payment. In one aspect, an amount may be credited to a financial account of the biller. In some cases, the credit amount may be the bill payment amount. In other cases, the credit amount may be different from the bill payment amount. Options for credit processing include sending a hardcopy payment instrument (e.g., check (drawn on a service provider account) or draft (drawn on the payer account) or sending payment to a remittance processor (e.g., MasterCard RPPS) that may in turn pay the payee. In one aspect, the payment system 170 may receive confirmation that the credit and/or debit transactions have been processed or will be processed from the corresponding financial institution computers 150. At block 1016, a confirmation of the payment may be transmitted. This confirmation may be transmitted by the payment system 170 to the user device 110 via the networks 140 or other suitable communicative connections. In some cases, the confirmation may entail confirmation of acceptance of the payment request for processing (i.e., eligibility) or that the appropriate debit and credit have been initiated. In some embodiments, there may be positive confirmation back from a payment network or FI, such as in the form of one or more messages.

It will be appreciated that method 1000 may make use of an intermediary account associated with the payment system 170 for executing the payment. For example, a debit transaction of a first value may be directed by the payment system 170 from a financial account of the payer resulting in a corresponding credit of the first value into an intermediary account of the payment system 170. Next, a credit transaction of a second value may be directed into a financial account of the biller, associated with a corresponding debit from an intermediary account of the payment system 170 (possibly the same intermediary account credited by the debit transaction). In some cases, the first value and the second value may be equal. In other cases, the first value and second value may be different. In some of these cases, the first value may be greater than the second value. In one non-limiting example, the first value may be equal to the bill payment due amount and the second value may be a value less than the bill payment due amount. In another non-limiting example, the first value may be greater than the bill payment due amount and the second value may be a value may be equal to the bill payment due amount.

In certain embodiments, if the due date of the payment is in the future by a predetermined period of time, then the payment system 170 may not immediately execute the bill payment transactions. Instead the payment system 170 may hold the payment request and process the payment request at a second predetermined period of time that is closer to the due date of the bill. In these embodiments, the payer 102 may receive confirmation of the payment request being accepted and stored, rather than confirmation of success or failure in processing the payment request.

It should be noted, that the method 1000 may be modified in various ways in accordance with certain embodiments of the disclosure. For example, one or more operations of the method 1000 may be eliminated or executed out of order in other embodiments of the disclosure. Additionally, other operations may be added to the method 1000 in accordance with other embodiments of the disclosure.

Embodiments described herein may be implemented using hardware, software, and/or firmware, for example, to perform the methods and/or operations described herein. Certain embodiments described herein may be provided as a tangible machine-readable medium storing machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device, or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the disclosure have been described in connection with what is presently considered to be the most practical embodiments, it is to be understood that the disclosure is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the disclosure and also to enable any person skilled in the art to practice certain embodiments of the disclosure, including making and using any devices or systems and performing any incorporated methods. The patentable scope of certain embodiments of the disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method, comprising:
receiving, by a computerized payment system comprising one or more computers and on behalf of a payer via a communications network, a first image representing at least a portion of a bill of a biller for the payer;
determining, by the computerized payment system, one or more bill data elements associated with the bill based at least in part on the first image;
transmitting, by the computerized payment system for presentation to the payer via the communications network, an indication of at least one of the one or more bill data elements;
receiving, by the computerized payment system on behalf of the payer via the communications network, at least one of: (i) confirmation of at least one of the one or more bill data elements or (ii) modification of at least one of the one or more bill data elements;
identifying, by the computerized payment system and based at least in part on receiving at least one of: (i) confirmation of the at least one of the one or more bill data elements or (ii) modification of at least one of the one or more bill data elements, one or more approved bill data elements;
receiving, by the computerized payment system on behalf of the payer via the communications network, a second image representing at least a portion of a payment instrument associated with a financial account of the payer;
determining, by the computerized payment system, one or more payment instrument data elements associated with the financial account based at least in part on the second image;
transmitting, by the computerized payment system for presentation to the payer via the communications network, an indication of at least one of the one or more payment instrument data elements;
receiving, by the computerized payment system on behalf of the payer via the communications network, at least one of: (i) confirmation of the at least one of the one or more payment instrument data elements or (ii) modification of the one or more payment instrument data elements;
identifying, by the computerized payment system and based at least in part on receiving at least one of: (i) confirmation of the at least one of the one or more payment instrument data elements or (ii) modification of at least one of the one or more payment instrument data elements, one or more approved payment instrument data elements; and
processing, by the computerized payment system, a payment request to pay the biller on behalf of the payer based at least in part on at least one of the one or more approved bill data elements and at least one of the one or more approved payment instrument data elements.

2. The method of claim 1, wherein receiving the first image comprises receiving, by the computerized payment system, the first image via the communications network from a user device associated with the payee.

3. The method of claim 1, wherein the portion of the bill comprises a bill payment coupon.

4. The method of claim 1, wherein the one or more bill data elements comprise at least one of: (i) an identification of the biller; (ii) an identification of the biller's address; (iii) an identification of the biller's payment address; (iv) an identification of the biller's telephone number; (v) an identification of a consumer; (vi) an identification of the consumer's account number; (vii) an identification of the consumer's address; (viii) an invoice number; (ix) a payment due date; (x) a payment amount.

5. The method of claim 1, wherein determining the one or more bill data elements comprises at least one of: (i) image filtering, by the computerized payment system, of the first image; (ii) image sharpening, by the computerized payment system, of the first image; (iii) modifying, by the computerized payment system, orientation of the first image; (iv) modifying, by the computerized payment system, dithering of one or more pixels of the first image; (v) modifying, by the computerized payment system, contrast of the first image; (vi) modifying, by the computerized payment system, brightness of the first image; (vii) processing, by the computerized payment system, metadata associated with the first image; (vii) image field recognition, by the payment system, of the first image; (viii) text sequence recognition, by the computerized payment system, of the first image; (ix) optical character recognition, by computerized the payment system, of the first image; or (x) intelligent character recognition, by the computerized payment system, of the first image.

6. The method of claim 1, wherein the payment instrument comprises at least one of: (i) a check; (ii) a credit card; (iii) a debit card; or (iv) a prepaid card.

7. The method of claim 1, wherein the second image comprises at least one of: (i) an image of a front of a check; (ii) an image of a back of a check; (iii) an image of a front of a credit card; (iv) an image of a back of a credit card; (v) an image of a front of a debit card; (vi) an image of a back of a debit card; (v) an image of a front of a prepaid card; (vi) an image of a back of a prepaid card.

8. The method of claim 1, wherein the one or more payment instrument data elements comprise at least one of: (i) an identification of a payment instrument type; (ii) an identification of the payer's address; (iii) an identification of the biller's payment address; (iv) an identification of the payer's telephone number; (v) an identification of the financial account; (vi) an identification of a financial account number; (vii) an identification of a routing number; (viii) an identification of a check number; (ix) an expiration date; (x) a card verification string; (xi) a card type; (xii) a card association; or (xiii) a card issuer.

9. The method of claim 1, wherein determining the one or more payment instrument data elements comprises at least one of: (i) image filtering, by the computerized payment system, of the second image; (ii) image sharpening, by the computerized payment system, of the second image; (iii) modifying, by the computerized payment system, orientation of the second image; (iv) modifying, by the computerized payment system, dithering of one or more pixels of the second image; (v) modifying, by the computerized payment system, contrast of the second image; (vi) modifying, by the computerized payment system, brightness of the second image; (vii) processing, by the computerized payment system, metadata associated with the second image; (vii) image field recognition, by the computerized payment system, of the second image; (viii) text sequence recognition, by the computerized payment system, of the second image; (ix) optical character recognition, by the computerized payment system, of the second image; or (x) intelligent character recognition, by the computerized payment system, of the second image.

10. A payment system, comprising:
one or more communications interfaces;
one or more memories that stores computer-executable instructions; and
one or more processors configured to access the one or more memories, wherein at least one of the one or more processors is further configured to execute the computer-executable instructions to:
receive on behalf of a payer via the one or more communications interfaces, a first image representing at least a portion of a bill of a biller for the payer;
determine one or more bill data elements associated with the bill based at least in part on the first image;
transmit for presentation to the payer via the one or more communications interfaces, an indication of at least one of the one or more bill data elements;
receive on behalf of the payer via the one or more communications interfaces, at least one of: (i) confirmation of the one or more bill data elements or (ii) modification of at least one of the one or more bill data elements;
identify based at least in part on receiving at least one of: (i) confirmation of the one or more bill data elements or (ii) modification of at least one of the one or more bill data elements, one or more approved bill data elements;
receive on behalf of the payer via the one or more communications interfaces, a second image representing at least a portion of a payment instrument associated with a financial account of the payer;
determine one or more payment instrument data elements associated with the financial account based at least in part on the second image;
transmit for presentation to the payer via the one or more communications interfaces, an indication of at least one of the one or more payment instrument data elements;
receive on behalf of the payer via the one or more communications interfaces, at least one of: (i) confirmation of the one or more payment instrument data elements or (ii) modification of the one or more payment instrument data elements;
identify based at least in part on receiving at least one of: (i) confirmation of the one or more payment instrument data elements or (ii) modification of at least one of the one or more payment instrument data elements, one or more approved payment instrument data elements; and
process a payment request to pay the biller on behalf of the payer based at least in part on at least one of the one or more approved bill data elements and at least one of the one or more approved payment instrument data elements.

11. The payment system of claim 10, wherein receiving the first image comprises receiving, by the payment system via the one or more communications interfaces, the first image from a user device associated with the payee.

12. The payment system of claim 10, wherein the one or more payment instrument data elements comprise at least one of: (i) an identification of a payment instrument type; (ii) an identification of the payer's address; (iii) an identification of the biller's payment address; (iv) an identification of the payer's telephone number; (v) an identification of the financial account; (vi) an identification of a financial account number; (vii) an identification of a routing number; (viii) an identification of a check number; (ix) an expiration date; (x) a card verification string; (xi) a card type; (xii) a card association; or (xiii) a card issuer.

13. The payment system of claim 10, wherein determining the one or more payment instrument data elements comprises at least one of: (i) image filtering, by the payment system, of the second image; (ii) image sharpening, by the payment system, of the second image; (iii) modifying, by the payment system, orientation of the second image; (iv) modifying, by the payment system, dithering of one or more pixels of the second image; (v) modifying, by the payment system, contrast of the second image; (vi) modifying, by the payment system, brightness of the second image; (vii) processing, by the payment system, metadata associated with the second image; (vii) image field recognition, by the payment system, of the second image; (viii) text sequence recognition, by the payment system, of the second image; (ix) optical character recognition, by the payment system, of the second image; or (x) intelligent character recognition, by the payment system, of the second image.

14. A method, comprising:
receiving, by a computerized payment application system comprising one or more computer processors and on behalf of a payer, a first image representing at least a portion of a bill of a biller for the payer;
providing, by the computerized payment application system for presentation to the payer, an indication of one or more bill data elements associated with the first image;
receiving, by the computerized payment application system on behalf of the payer, at least one of: (i) confirmation of the one or more bill data elements or (ii) modification of at least one of the one or more bill data elements, wherein one or more approved bill data elements is identified based on the one or more bill data elements and the at least one of: (i) confirmation of the one or more bill data elements or (ii) modification of at least one of the one or more bill data elements;
receiving, by the computerized payment application system, a second image representing at least a portion of a payment instrument associated with a financial account of the payer;
providing, by the computerized payment application system to the payer, an indication of one or more payment instrument data elements associated with the second image;
receiving, by the computerized payment application system from the payer, at least one of: (i) confirmation of the one or more payment instrument data elements or (ii) modification of one or more of the one or more payment instrument data elements, wherein one or more approved payment instrument data elements are identified based at least in part on the one or more payment instrument data elements and the at least one of (i) confirmation of the one or more payment instrument data elements or (ii) modification of one or more of the one or more payment instrument data elements; and
transmitting, by the computerized payment application system to a payment system via a communications network, a payment request to pay the biller on behalf of the payer based at least in part on at least one of the one or more approved bill data elements and at least one of the one or more approved payment instrument data elements.

15. The method of claim 14, wherein receiving the first image comprises at least one of: (i) capturing, by the computerized payment application system, the first image; or (ii) receiving, by the computerized payment application system, the first image from the biller.

16. The method of claim 14, further comprising transmitting, by the computerized payment application system the first image to the payment system.

17. The method of claim 14, wherein providing for presentation to the payer, an indication of one or more bill data elements associated with the first image comprises receiving the indication of one or more bill data elements form the payment system.

18. The method of claim 14, further comprising transmitting the one or more approved bill data elements to the payment system.

19. The method of claim 14, wherein receiving the second image comprises capturing, by the computerized payment application system, the second image.

20. The method of claim 14, further comprising transmitting, by the computerized payment application system the second image to the payment system.

21. The method of claim 14, wherein providing for presentation to the payer, an indication of one or more payment instrument data elements associated with the second image comprises receiving the indication of one or more payment instrument data elements form the computerized payment system.

22. The method of claim 14, further comprising transmitting the one or more approved payment instrument data elements to the computerized payment system.

23. A payment application system, comprising:
one or more communications interfaces;
one or more memories that stores computer-executable instructions; and
one or more processors configured to access the one or more memories, wherein at least one of the one or more processors is further configured to execute the computer-executable instructions to:
receive on behalf of a payer, a first image representing at least a portion of a bill of a biller for the payer;
provide for presentation to the payer, an indication of one or more bill data elements associated with the first image;
receive, at least one of: (i) confirmation of the one or more bill data elements or (ii) modification of at least one of the one or more bill data elements, wherein one or more approved bill data elements is identified based on the one or more bill data elements and the at least one of: (i) confirmation of the one or more bill data elements or (ii) modification of at least one of the one or more bill data elements;
receive a second image representing at least a portion of a payment instrument associated with a financial account of the payer;
provide an indication of one or more payment instrument data elements associated with the second image;
receive at least one of: (i) confirmation of the one or more payment instrument data elements or (ii) modification of one or more of the one or more payment instrument data elements, wherein one or more approved payment instrument data elements are identified based at least in part on the one or more payment instrument data elements and the at least one of (i) confirmation of the one or more payment instrument data elements or (ii) modification of one or more of the one or more payment instrument data elements; and
transmit via the one or more communications interfaces to a payment system, a payment request to pay the biller on behalf of the payer based at least in part on at least one of the one or more approved bill data elements and at least one of the one or more approved payment instrument data elements.

24. The payment application system of claim 23, further comprising one or more image scanners configured to capture at least one of the first image or the second image.

25. The payment application system of claim 23, wherein the one or more bill data elements comprise at least one of: (i) an identification of the biller; (ii) an identification of the biller's address; (iii) an identification of the biller's payment address; (iv) an identification of the biller's telephone number; (v) an identification of a consumer; (vi) an identification of the consumer's account number; (vii) an identification of the consumer's address; (viii) an invoice number; (ix) a payment due date; (x) a payment amount.

26. The payment application system of claim 23, wherein the payment instrument comprises at least one of: (i) a check; (ii) a credit card; (iii) a debit card; or (iv) a prepaid card.

27. The payment application system of claim 23, wherein the one or more payment instrument data elements comprise at least one of: (i) an identification of a payment instrument type; (ii) an identification of the payer's address; (iii) an identification of the biller's payment address; (iv) an identification of the payer's telephone number; (v) an identification of the financial account; (vi) an identification of a financial account number; (vii) an identification of a routing number; (viii) an identification of a check number; (ix) an expiration date; (x) a card verification string; (xi) a card type; (xii) a card association; or (xiii) a card issuer.
